(19) United States
(12) Patent Application Publication
(10) Pub. No.: US 2007/0287326 A1
(43) Pub. Date: Dec. 13, 2007

(54) Temporary battery cable reconnector

(76) Inventor: Joseph J. Grippe, Bayville, NJ (US)

Correspondence Address: Galasso & Associates, LP, P.O. Box 26503, Austin, TX, 78755-0503, US

(21) Appl. No.: 11/451,009

(22) Filed: Jun. 12, 2006

(51) Int. Cl. H01R 11/00

(52) U.S. Cl. 439/504

(57) ABSTRACT

Temporary Battery Cable Reconnector has a cable, two clamps with insulated handles, a pin attached to one of the clamps, and a chain with a socket for accepting the pin attached to one of the clamps. To use Temporary Battery Cable Reconnector, a user simply attaches the two clamps to the terminals of the battery and the pin is inserted into the housing of the cut wire cable to reestablish a link to provide the desired electrical conduit necessary to operate a vehicle's electrical systems.

### CROSS REFERENCE TO RELATED APPLICATIONS

This Non-Provisional Patent Application does not claim priority to any U.S. provisional patent application nor any foreign patent application.

### FIELD OF THE DISCLOSURE

The disclosures made herein relate generally to the automobile industry. The invention discussed herein is in the general classification of automotive devices.

### BACKGROUND

Millions of people drive automobiles everyday. As a result of the increased traffic on the roads, traffic accidents continue to occur everyday. With road construction, traffic, unpredictable weather conditions and driver error, accidents are impossible to eliminate in their entirety.

When emergency personnel respond to an accident scene, they must follow a prescribed protocol for efficiently and safely aiding the accident victims. These steps insure the integrity of the scene as well as address the needs of the victims of the accident. One step that is taken, for example, is the cutting of the vehicle's battery cable as a caution against electrical accidents such as fire. Often, a vehicle is still drivable after the battery cables are cut, but there is no way to provide the necessary power to the vehicle. As a result, the disabled vehicle needs to be towed to a repair shop to reinstall the battery cable connection when emergency personnel have completed their job.

Hence, there is a need in the art for an easy to use, inexpensive and effective device that will permit a vehicle's battery cable to be reconnected after it is cut to allow a vehicle to be operated without the need for expensive towing.

### SUMMARY OF THE DISCLOSURE

Temporary Battery Cable Reconnector consists of a cable, two clamps and a pin. To use Temporary Battery Cable Reconnector, a user simply attaches the two clamps to the two terminals of a battery and the pin is inserted into the housing of the cut wire cable to reestablish a link to provide the desired electrical conduit necessary to operate a vehicle's electrical systems.

The principal object of this invention is to provide a device for reconnecting terminals of a battery to a cut cable.

Another object of this invention is to provide a temporary solution for establishing battery power to a vehicle.

Another object of this invention is to provide an affordable reconnection device for a battery of a vehicle.

Yet another object of this invention is to provide an easy to use reconnection device for the battery of a vehicle.

### BRIEF DESCRIPTION OF THE DRAWINGS

FIG. 1 depicts a perspective view of the preferred embodiment of the invention.

FIG. 2 depicts a frontal view of one of the clamps of the preferred embodiment of the invention.

### DETAILED DESCRIPTION OF THE DRAWINGS

The preferred embodiment of Temporary Battery Cable Reconnector is comprised of at least some of the following: a cable, two clamps with insulated handles, a pin attached to one of the clamps, and a chain with a socket for accepting the pin attached to one of the clamps.

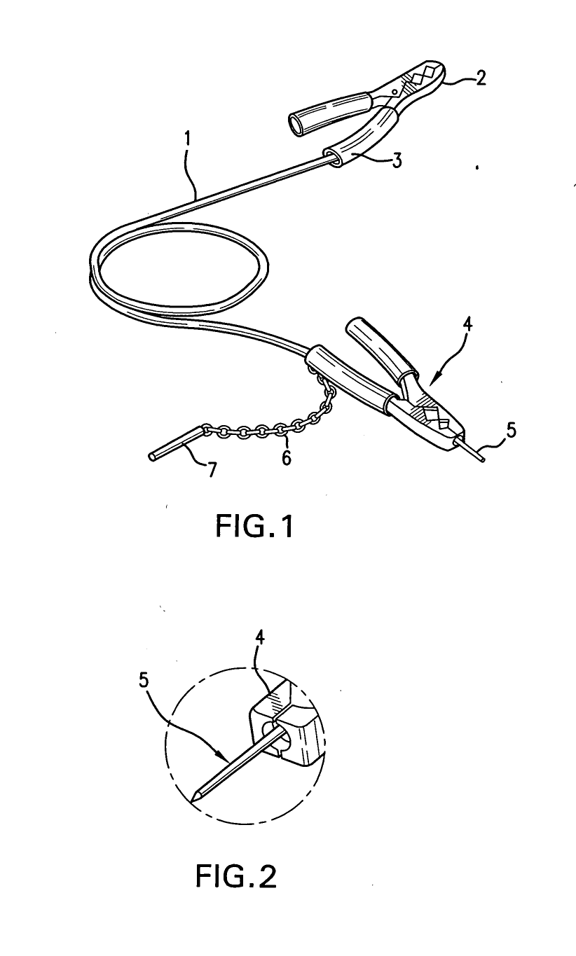

In the preferred embodiment of the invention, shown in FIG. 1, a cable is made of copper strand and is covered by an insulating layer 1. The cable and insulating layer 1 are approximately four feet long and connect on one end to a handle that is attached to a clamp 2 made of metal. The handle also has insulating rubber 3 covering it. The cable connects on the other end to a second handle that is attached to a second clamp 4 also made of metal. The second handle is also covered by insulating rubber or plastic material. The second clamp 4 has a pin 5 protruding from the top. The pin 5 is approximately three inches long and made of metal. The second handle also has a chain 6 attached to the bottom with a socket 7 adapted to cover the pin 5 when the device is not in use. The chain is made of metal and the socket is made of plastic or rubber in this preferred embodiment.

FIG. 2 shows a close-up frontal view of the second clamp 4 with the pin 5. The pin 5 and top of the second clamp 4 are clearly shown in this view. The pin 5 has appropriate dimensions to be inserted within the insulative housing of a typical battery cable.

To use Temporary Battery Cable Reconnector, a user simply attaches the two clamps to the terminals of the battery and the pin is inserted into the housing of the cut wire cable to reestablish a link to provide the desired electrical conduit necessary to operate a vehicle's electrical systems.

The components of Temporary Battery Cable Reconnector may vary widely but will likely use metal, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Temporary Battery Cable Reconnector can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the clamps, handles, cable, pin and other components of the invention can be made of different types of metals, plastics or other suitable materials and can be of any color. It should further be obvious that although the present invention is ordinarily used within cars and trucks, it could be used with a large number of motorized vehicles or devices. Such vehicles or devices include ships, trains, farm equipment, construction equipment and hybrid vehicles. The present invention could be used with any device having a battery and cables connecting the battery to the device. It should also be obvious that while the cable of the present invention is connected to a handle attached to a clamp, it could be attached directly to the clamp. Hence, the term “handle” simply means a location on or attachment connected to the clamp.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A battery accessory comprising:
(a) a cable connected on one end to a first handle and on the other end to a second handle;
(b) a first clamp and a second clamp made of metal that are operatively attached to the cable through the first handle and the second handle;
(c) a pin made of metal protruding from the second clamp; wherein said pin is capable of being inserted into a cut wire cable;
(d) a socket adapted to cover the pin; and
(e) a chain connected to the bottom of the second handle on one end and to the socket on the other end.

2. The battery accessory of claim 1 wherein the cable is made of copper strand.

3. The battery accessory of claim 1 wherein the cable is approximately four feet in length.

4. The battery accessory of claim 1 wherein the cable has an insulating material extending approximately the entire length of the cable.

5. The battery accessory of claim 4 wherein the insulating material is plastic.

6. The battery accessory of claim 4 wherein the insulating material is rubber.

7. The battery accessory of claim 1 wherein the first handle and the second handle are covered by an insulating rubber.

8. The battery accessory of claim 1 wherein the first handle and the second handle are covered by an insulating plastic.

9. The battery accessory of claim 1 wherein a chain is attached to one of the bottom of the second handle and on the other end to a socket adapted to cover the pin.

10. The battery accessory of claim 9 wherein the chain is made of metal.

11. The battery accessory of claim 9 wherein the socket is made of plastic.

12. The battery accessory of claim 9 wherein the socket is made of rubber.

13. A battery accessory comprising:
(a) a cable made of copper strand and insulated with plastic connected on one end to a first handle insulated with rubber and on the other end to a second handle insulated with rubber;
(b) a first clamp and a second clamp made of metal that operatively attach to the cable through the first handle and the second handle;
(c) a pin made of steel protruding from the second clamp; and
(d) a chain made of metal attached on one end to the bottom of the second handle and on the other to a socket made of plastic adapted to cover the pin.
